(19) United States
(12) Patent Application Publication
(10) Pub. No.: US 2022/0222834 A1
(43) Pub. Date: Jul. 14, 2022

(54) IMAGE PROCESSING SYSTEM, IMAGE PROCESSING DEVICE, IMAGE PROCESSING METHOD, AND PROGRAM

(71) Applicant: NIPPON TELEGRAPH AND TELEPHONE CORPORATION, Tokyo (JP)

(72) Inventor: Kazu MIYAKAWA, Tokyo (JP)

(73) Assignee: NIPPON TELEGRAPH AND TELEPHONE CORPORATION, Tokyo (JP)

(21) Appl. No.: 17/638,758

(22) PCT Filed: Aug. 27, 2019
(86) PCT No.: PCT/JP2019/033582

§ 371 Date: Feb. 25, 2022

(51) Int. Cl. G06T 7/33; B64D 47/08; B64C 39/02

(52) U.S. Cl. CPC G06T 7/33; B64D 47/08; B64C 2201/123; G06T 2207/10032; B64C 39/024

(57) ABSTRACT

An image processing system (100) includes an imaging range specification unit (52), an overlapping region estimation unit (53), a transformation parameter calculation unit (54), and a frame image synthesis unit (55). The imaging range specification unit (52) specifies first imaging information based on first state information indicating a state of a first unmanned aerial vehicle (101) and second state information indicating a state of a first camera (107a), and specifies second imaging information based on third state information indicating a state of a second unmanned aerial vehicle (102) and fourth state information indicating a state of a second camera (107b). The overlapping region estimation unit (53) calculates a corrected first overlapping region and a corrected second overlapping region in a case where an error of a first overlapping region and a second overlapping region exceeds a threshold. The transformation parameter calculation unit (54) calculates a transformation parameter using the corrected first overlapping region and the corrected second overlapping region. The frame image synthesis unit (55) synthesizes a first frame image after projective transformation and a second frame image after projective transformation.

### TECHNICAL FIELD

The present disclosure relates to an image processing system, an image processing device, an image processing method, and a program.

### BACKGROUND ART

With a reduction in the size of equipment, improvement of accuracy, an increase in battery capacity, and the like, live video distribution performed by professionals or amateurs using miniature cameras represented by action cameras is being actively performed. Such miniature cameras often use an ultra-wide-angle lens having a horizontal viewing angle of more than 120° and can capture a wide range of videos (highly realistic panoramic videos) with a sense of realism. However, because a wide range of information is contained within one lens, a large amount of information is lost due to peripheral distortion of the lens, and quality degradation such as images becoming rougher toward the periphery of a video occurs.

In this manner, because it is difficult to capture a highly realistic panoramic video having high quality with one camera, there is a technique of combining videos captured using a plurality of high-definition cameras to make the videos look as if they are a panoramic video obtained by capturing a wide range of landscapes with one camera (NPL 1).

Because each camera captures images within a certain range in the lens, a panoramic video using a plurality of cameras is a high-definition and high-quality panoramic video (highly-realistic high-definition panoramic video) in every corner of a screen as compared to a video captured using a wide-angle lens.

In capturing such a panoramic video, a plurality of cameras capture images in different directions around a certain point, and when the images are synthesized as a panoramic video, a correspondence relation between frame images is identified using feature points or the like to perform projective transformation (homography). The projective transformation is a transformation in which a certain quadrangle (plane) is transferred to another quadrangle (plane) while maintaining the straightness of its sides, and as a general method, transformation parameters are estimated by associating (matching) feature points with each feature point group on two planes. Distortion due to the orientation of a camera is removed by using the projective transformation, and frame image groups can be projected onto one plane as if they were captured with one lens, so that it is possible to perform synthesis without a feeling of discomfort (see FIG. 4).

On the other hand, in a case where parameters are not estimated correctly due to an error in a correspondence relation between feature points, a shift occurs between frame images of each camera, and inconsistency of unnatural lines or images and the like occur at a connection portion. Thus, panoramic video capture using a plurality of cameras is generally performed with a camera group firmly fixed.

### CITATION LIST

### Non Patent Literature

NPL 1: NTT, “53rd ultra-wide video synthesis technique”, [online], [accessed on Aug. 19, 2019], the Internet <URL: http://www.ntt.co.jp/svlab/activity/pickup/qa53.html>

### SUMMARY OF THE INVENTION

### Technical Problem

In recent years, unmanned aerial vehicles (UAV) having a weight of about a few kilograms have become widely used, and the act of mounting a miniature camera or the like to perform image capture is becoming common. Because an unmanned aerial vehicle is small in size, it is characterized by making it possible to easily perform image capture in various places and to operate at a lower cost than a manned aerial vehicle such as a helicopter.

Because image capture using an unmanned aerial vehicle is expected to be used for public purposes such as rapid information collection in a disaster area, it is desirable to capture a wide range of videos with as high definition as possible. Thus, a method of capturing a highly-realistic high-definition panoramic video using a plurality of cameras as in NPL 1 is expected.

While the unmanned aerial vehicle has the advantage of being small in size, it cannot carry too many things due to a small output of its motor. It is necessary to increase the size in order to increase load capacity, but cost advantages are canceled out. For this reason, in a case where a highly-realistic high-definition panoramic video is captured while taking advantage of the unmanned aerial vehicle, that is, a case where a plurality of cameras are mounted on one unmanned aerial vehicle, many problems to be solved, such as weight or power supply, occur. In addition, because a panoramic video synthesis technique can synthesize panoramic videos in various directions such as vertical, horizontal, and square directions depending on an algorithm to be adopted, it is desirable to be capable of selectively determining the arrangement of cameras according to an imaging object and an imaging purpose. However, because complicated equipment that changes the position of the camera cannot be mounted during operation, the camera must be fixed in advance, and only static operation can be performed.

As a method of solving such a problem, operating a plurality of unmanned aerial vehicles having cameras mounted thereon can be considered. A reduction in size is possible by reducing the number of cameras to be mounted on each unmanned aerial vehicle, and the arrangement of cameras can also be determined dynamically because each of the unmanned aerial vehicles can move.

While it is ideal to capture a panoramic video using such a plurality of unmanned aerial vehicles, it is very difficult to perform video synthesis because the cameras need to face their respective different directions in order to capture the panoramic video. In order to perform projective transformation, each camera video is provided with overlapping regions, but it is difficult to specify where each region is captured from an image, and it is difficult to extract a feature point for synthesizing videos from the overlapping regions. In addition, the unmanned aerial vehicle attempts to stay at a fixed place using position information of a global positioning system (GPS) or the like, but it may not stay in the same place accurately due to a disturbance such as a strong wind, a delay in motor control, or the like. For this reason, it is also difficult to specify an imaging region from the position information or the like.

An object of the present disclosure contrived in view of such circumstances is to provide an image processing system, an image processing device, an image processing method, and a program that make it possible to generate a highly-realistic high-definition panoramic video with high accuracy utilizing the lightweight properties of an unmanned aerial vehicle without firmly fixing a plurality of cameras.

### Means for Solving the Problem

According to an embodiment, there is provided an image processing system configured to synthesize frame images captured by cameras mounted on unmanned aerial vehicles, the image processing system including: a frame image acquisition unit configured to acquire a first frame image captured by a first camera mounted on a first unmanned aerial vehicle and a second frame image captured by a second camera mounted on a second unmanned aerial vehicle; a state information acquisition unit configured to acquire first state information indicating a state of the first unmanned aerial vehicle, second state information indicating a state of the first camera, third state information indicating a state of the second unmanned aerial vehicle, and fourth state information indicating a state of the second camera; an imaging range specification unit configured to specify first imaging information that defines an imaging range of the first camera based on the first state information and the second state information and specify second imaging information that defines an imaging range of the second camera based on the third state information and the fourth state information; an overlapping region estimation unit configured to calculate a first overlapping region in the first frame image and a second overlapping region in the second frame image based on the first imaging information and the second imaging information, and calculate a corrected first overlapping region obtained by correcting the first overlapping region and a corrected second overlapping region obtained by correcting the second overlapping region in a case where an error of the first overlapping region and the second overlapping region exceeds a threshold; a transformation parameter calculation unit configured to calculate transformation parameters for performing projective transformation on the first frame image and the second frame image using the corrected first overlapping region and the corrected second overlapping region; and a frame image synthesis unit configured to perform projective transformation on the first frame image and the second frame image based on the transformation parameters and synthesize the first frame image after the projective transformation and the second frame image after the projective transformation.

According to an embodiment, there is provided an image processing device configured to synthesize frame images captured by cameras mounted on unmanned aerial vehicles, the image processing device including: an imaging range specification unit configured to acquire first state information indicating a state of a first unmanned aerial vehicle, second state information indicating a state of a first camera mounted on the first unmanned aerial vehicle, third state information indicating a state of a second unmanned aerial vehicle, and fourth state information indicating a state of a second camera mounted on the second unmanned aerial vehicle, specify first imaging information that defines an imaging range of the first camera based on the first state information and the second state information, and specify second imaging information that defines an imaging range of the second camera based on the third state information and the fourth state information; an overlapping region estimation unit configured to calculate a first overlapping region in a first frame image captured by the first camera and a second overlapping region in a second frame image captured by the second camera based on the first imaging information and the second imaging information, and calculate a corrected first overlapping region obtained by correcting the first overlapping region and a corrected second overlapping region obtained by correcting the second overlapping region in a case where an error of the first overlapping region and the second overlapping region exceeds a threshold; a transformation parameter calculation unit configured to calculate transformation parameters for performing projective transformation on the first frame image and the second frame image using the corrected first overlapping region and the corrected second overlapping region; and a frame image synthesis unit configured to perform projective transformation on the first frame image and the second frame image based on the transformation parameters and synthesize the first frame image after the projective transformation and the second frame image after the projective transformation.

According to an embodiment, there is provided an image processing method of synthesizing frame images captured by cameras mounted on unmanned aerial vehicles, the image processing method including: acquiring a first frame image captured by a first camera mounted on a first unmanned aerial vehicle and a second frame image captured by a second camera mounted on a second unmanned aerial vehicle; acquiring first state information indicating a state of the first unmanned aerial vehicle, second state information indicating a state of the first camera, third state information indicating a state of the second unmanned aerial vehicle, and fourth state information indicating a state of the second camera; specifying first imaging information that defines an imaging range of the first camera based on the first state information and the second state information and specifying second imaging information that defines an imaging range of the second camera based on the third state information and the fourth state information; calculating a first overlapping region in the first frame image and a second overlapping region in the second frame image based on the first imaging information and the second imaging information, and calculating a corrected first overlapping region obtained by correcting the first overlapping region and a corrected second overlapping region obtained by correcting the second overlapping region in a case where an error of the first overlapping region and the second overlapping region exceeds a threshold; calculating transformation parameters for performing projective transformation on the first frame image and the second frame image using the corrected first overlapping region and the corrected second overlapping region; and performing projective transformation on the first frame image and the second frame image based on the transformation parameters and synthesizing the first frame image after the projective transformation and the second frame image after the projective transformation.

According to an embodiment, there is provided a program for causing a computer to function as the image processing device.

### Effects of the Invention

According to the present disclosure, it is possible to generate a highly-realistic high-definition panoramic video with high accuracy utilizing the lightweight properties of an unmanned aerial vehicle without firmly fixing a plurality of cameras.

### BRIEF DESCRIPTION OF DRAWINGS

FIG. 1 is a diagram illustrating a configuration example of a panoramic video synthesis system according to an embodiment.

FIG. 2 is a block diagram illustrating a configuration example of the panoramic video synthesis system according to the embodiment.

FIG. 3 is a flow chart illustrating an image processing method of the panoramic video synthesis system according to the embodiment.

FIG. 4 is a diagram illustrating synthesis of frame images through projective transformation.

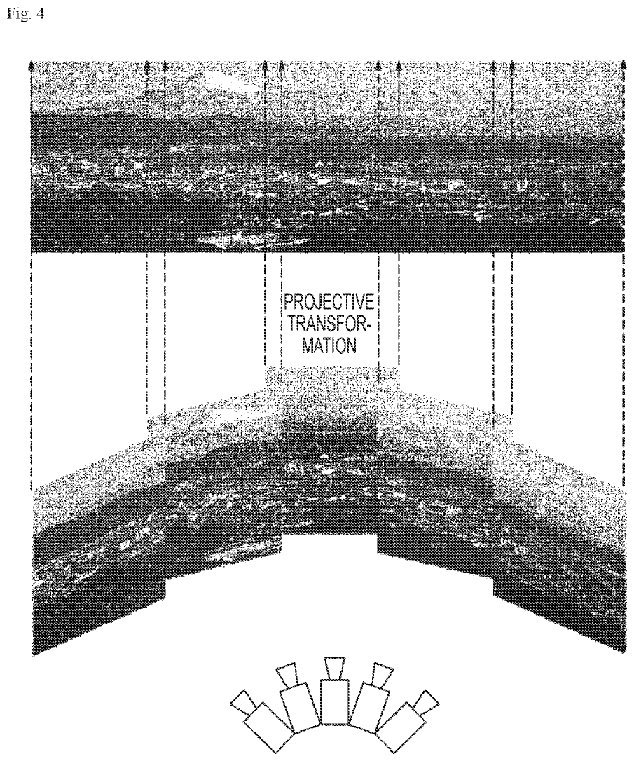

### DESCRIPTION OF EMBODIMENTS

Hereinafter, an aspect for carrying out the present invention will be described with reference to the accompanying drawings.

Configuration of Panoramic Video Synthesis System

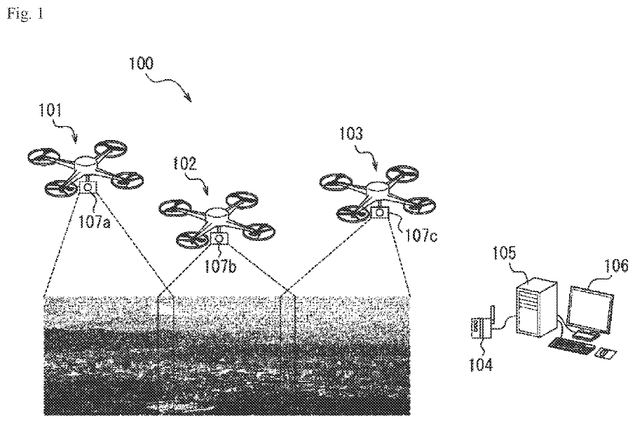

FIG. 1 is a diagram illustrating a configuration example of a panoramic video synthesis system (image processing system) 100 according to an embodiment of the present invention.

As illustrated in FIG. 1, the panoramic video synthesis system 100 includes unmanned aerial vehicles 101, 102, and 103, a radio reception device 104, a calculator (image processing device) 105, and a display device 106. The panoramic video synthesis system 100 is used for generating a highly-realistic high-definition panoramic video by synthesizing frame images captured by cameras mounted on an unmanned aerial vehicle.

The unmanned aerial vehicles 101, 102, and 103 are small unmanned flight objects having a weight of about a few kilograms. A camera 107a is mounted on the unmanned aerial vehicle 101, a camera 107b is mounted on the unmanned aerial vehicle 102, and a camera 107c is mounted on the unmanned aerial vehicle 103.

Each of the cameras 107a, 107b, and 107c captures an image in a different direction. Video data of videos captured by the cameras 107a, 107b, and 107c is wirelessly transmitted from the unmanned aerial vehicles 101, 102, and 103 to the radio reception device 104. In the present embodiment, a case where one camera is mounted on one unmanned aerial vehicle will be described as an example, but two or more cameras may be mounted on one unmanned aerial vehicle.

The radio reception device 104 receives the video data of the videos captured by the cameras 107a. 107b, and 107c wirelessly transmitted from the unmanned aerial vehicles 101, 102, and 103 in real time, and outputs the video data to the calculator 105. The radio reception device 104 is a general wireless communication device having a function of receiving a wirelessly transmitted signal.

The calculator 105 synthesizes the videos captured by the cameras 107a. 107b, and 107c shown in the video data received by the radio reception device 104 to generate a highly-realistic high-definition panoramic video.

The display device 106 displays the highly-realistic high-definition panoramic video generated by the calculator 105.

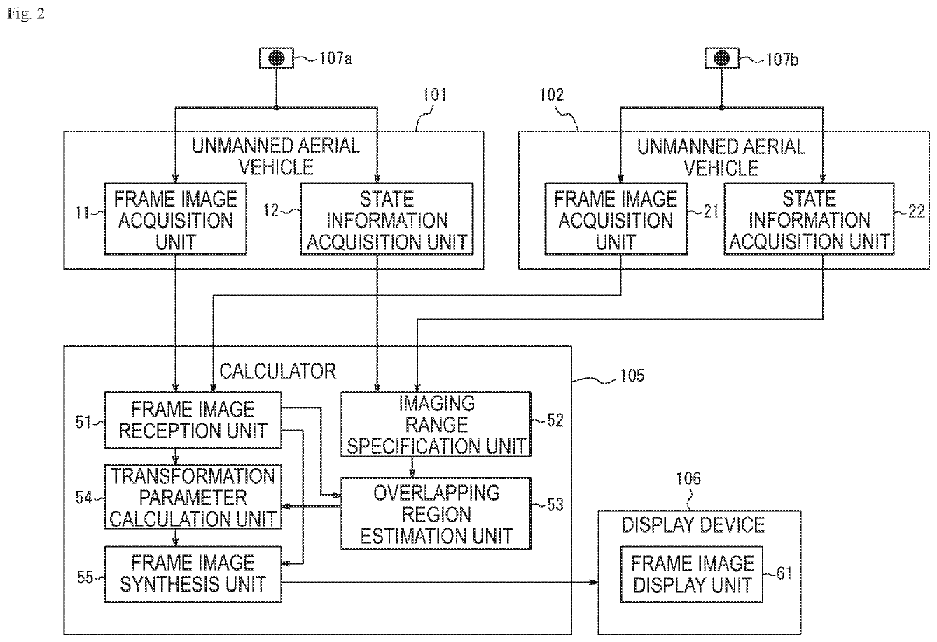

Next, the configurations of the unmanned aerial vehicles 101 and 102, the calculator 105, and the display device 106 will be described with reference to FIG. 2. Meanwhile, in the present embodiment, for convenience of description, only the configuration of the unmanned aerial vehicles 101 and 102 will be described, but the configuration of the unmanned aerial vehicle 103 or the third and subsequent unmanned aerial vehicles is the same as the configuration of the unmanned aerial vehicles 101 and 102, and thus the same description can be applied.

The unmanned aerial vehicle 101 (first unmanned aerial vehicle) includes a frame image acquisition unit 11 and a state information acquisition unit 12. The unmanned aerial vehicle 102 (second unmanned aerial vehicle) includes a frame image acquisition unit 21 and a state information acquisition unit 22. Meanwhile, FIG. 2 illustrates only components which are particularly relevant to the present invention among components of the unmanned aerial vehicles 101 and 102. For example, components allowing the unmanned aerial vehicles 101 and 102 to fly or perform wireless transmission are not described.

The frame image acquisition unit 11 acquires, for example, a frame image fₜ^{107a} (first frame image) captured by the camera 107a (first camera) at time t, and wirelessly transmits the acquired frame image to the radio reception device 104. The frame image acquisition unit 21 acquires, for example, a frame image fₜ^{107b} (second frame image) captured by the camera 107b (second camera) at time t, and wirelessly transmits the acquired frame image to the radio reception device 104.

The state information acquisition unit 12 acquires, for example, state information Sₜ^{v102} (first state information) indicating the state of the unmanned aerial vehicle 101 at time t. The state information acquisition unit 22 acquires, for example, state information Sₜ^{v102} (third state information) indicating the state of the unmanned aerial vehicle 102 at time t. The state information acquisition units 12 and 22 acquire, for example, position information of the unmanned aerial vehicles 101 and 102, as the state information Sₜ^{v101} and Sₜ^{v102}, based on a GPS signal. In addition, the state information acquisition units 12 and 22 acquire, for example, altitude information of the unmanned aerial vehicles 101 and 102, as the state information Sₜ^{v101} and Sₜ¹⁰², using altimeters provided in the unmanned aerial vehicles 101 and 102. In addition, the state information acquisition units 12 and 22 acquire, for example, posture information of the unmanned aerial vehicles 101 and 102, as the state information Sₜ^{v101} and Sₜ^{v102}, using gyro sensors provided in the unmanned aerial vehicles 101 and 102.

The state information acquisition unit 12 acquires, for example, state information Sₜ^{c101} (second state information) indicating the state of the camera 107a at time t. The state information acquisition unit 22 acquires, for example, state information Sₜ^{c102} (fourth state information) indicating the state of the camera 107b at time t. The state information acquisition units 12 and 22 acquire, as the state information Sₜ^{c101} and Sₜ^{c102}, for example, information of the orientations of the cameras 107a and 107b, information of the types of lenses of the cameras 107a and 107b, information of the focal lengths of the cameras 107a and 107b, information of the lens focuses of the cameras 107a and 107b, and information of the diaphragms of the cameras 107a and 107b, using various types of sensors provided in the cameras 107a and 107b, fixing instruments of the cameras 107a and 107b, or the like. Meanwhile, state information that can be set in advance, such as the information of the types of lenses of the cameras 107a and 107b may be set in advance as set values of the state information.

The state information acquisition unit 12 wirelessly transmits the acquired state information Sₜ^{v101} and Sₜ^{c101} to the radio reception device 104. The state information acquisition unit 22 wirelessly transmits the acquired state information Sₜ^{v102} and Sₜ^{c102} to the radio reception device 104.

As illustrated in FIG. 2, the calculator 105 includes a frame image reception unit 51, an imaging range specification unit 52, an overlapping region estimation unit 53, a transformation parameter calculation unit 54, and a frame image synthesis unit 55.

Each function of the frame image reception unit 51, the imaging range specification unit 52, the overlapping region estimation unit 53, the transformation parameter calculation unit 54, and the frame image synthesis unit 55 can be realized by executing a program stored in a memory of the calculator 105 using a processor or the like. In the present embodiment, the “memory” is, for example, a semiconductor memory, a magnetic memory, an optical memory, or the like, but is not limited thereto. In addition, in the present embodiment, the “processor” is a general-purpose processor, a processor adapted for a specific process, or the like, but is not limited thereto.

The frame image reception unit 51 wirelessly receives the frame image fₜ^{107a} wirelessly transmitted from the unmanned aerial vehicle 101 through the radio reception device 104. That is, the frame image reception unit 51 acquires the frame image fₜ^{107a} captured by the camera 107a. In addition, the frame image reception unit 51 wirelessly receives the frame image fₜ^{107b} wirelessly transmitted from the unmanned aerial vehicle 102 through the radio reception device 104. That is, the frame image reception unit 51 acquires the frame image fₜ^{107b} captured by the camera 107b.

Meanwhile, the frame image reception unit 51 may acquire the frame images fₜ^{107a} and fₜ^{107b} from the unmanned aerial vehicles 101 and 102, for example, through a cable or the like, without using wireless communication. In this case, the radio reception device 104 is not required.

The frame image reception unit 51 outputs the acquired frame images fₜ^{107a} and fₜ^{107b} to the transformation parameter calculation unit 54.

The imaging range specification unit 52 wirelessly receives the state information Sₜ^{v101} and Sₜ^{c101} wirelessly transmitted from the unmanned aerial vehicle 101 through the radio reception device 104. That is, the imaging range specification unit 52 acquires the state information Sₜ^{v101} indicating the state of the unmanned aerial vehicle 101 and the state information Sₜ^{c101} indicating the state of the camera 107a. In addition, the imaging range specification unit 52 wirelessly receives the state information Sₜ^{v102} and Sₜ^{c102} wirelessly transmitted from the unmanned aerial vehicle 102 through the radio reception device 104. That is, the imaging range specification unit 52 acquires the state information Sₜ^{v102} indicating the state of the unmanned aerial vehicle 102 and the state information Sₜ^{c102} indicating the state of the camera 107b.

Meanwhile, the imaging range specification unit 52 may acquire, from the unmanned aerial vehicles 101 and 102, the state information Sₜ^{v101} indicating the state of the unmanned aerial vehicle 101, the state information Sₜ^{c101} indicating the state of the camera 107a, the state information Sₜ^{v102} indicating the state of the unmanned aerial vehicle 102, and the state information Sₜ^{c102} indicating the state of the camera 107b, for example, through a cable or the like, without using wireless communication. In this case, the radio reception device 104 is not required.

The imaging range specification unit 52 specifies the imaging range of the camera 107a based on the acquired state information Sₜ^{v101} of the unmanned aerial vehicle 101 and the acquired state information Sₜ^{c101} of the camera 107a.

Specifically, the imaging range specification unit 52 specifies the imaging range of the camera 107a such as an imaging position and a viewpoint center based on the state information Sₜ^{v101} of the unmanned aerial vehicle 101 and the state information Sₜ^{c101} of the camera 107a. The state information Sₜ^{v101} of the unmanned aerial vehicle 101 includes the position information such as the latitude and longitude of the unmanned aerial vehicle 101 acquired based on a GPS signal, the altitude information of the unmanned aerial vehicle 101 acquired from various types of sensors provided in the unmanned aerial vehicle 101, the posture information of the unmanned aerial vehicle 101, or the like. The state information Sₜ^{c101} of the camera 107a includes the information of the orientation of the camera 107a or the like. In addition, the imaging range specification unit 52 specifies the imaging range of the camera 107a such as an imaging angle of view, based on the state information Sₜ^{c101} of the camera 107a. The state information Sₜ^{c101} of the camera 107a includes the information of the type of lens of the camera 107a, the information of the focal length of the camera 107a, the information of the lens focus of the camera 107a, the information of the diaphragm of the camera 107a, or the like.

The imaging range specification unit 52 specifies imaging information Pₜ^{107a} of the camera 107a. The imaging information Pₜ¹⁰⁷ of the camera 107a defines the imaging range of the camera 107a such as the imaging position, the viewpoint center, or the imaging angle of view.

The imaging range specification unit 52 specifies the imaging range of the camera 107b based on the acquired state information Sₜ^{v102} of the unmanned aerial vehicle 102 and the acquired state information Sₜ^{c102} of the camera 107b.

Specifically, the imaging range specification unit 52 specifies the imaging range of the camera 107b such as an imaging position and a viewpoint center based on the state information Sₜ^{v102} of the unmanned aerial vehicle 102 and the state information Sₜ^{c102} of the camera 107b. The state information Sₜ^{v102} of the unmanned aerial vehicle 102 includes the position information such as the latitude and longitude of the unmanned aerial vehicle 102 acquired based on a GPS signal, the altitude information of the unmanned aerial vehicle 102 acquired from various types of sensors provided in the unmanned aerial vehicle 102, the posture information of the unmanned aerial vehicle 102, or the like. The state information Sₜ^{c102} of the camera 107b includes the information of the orientation of the camera 107b. In addition, the imaging range specification unit 52 specifies the imaging range of the camera 107b such as an imaging angle of view based on the state information Sₜ^{c102} of the camera 107b. The state information Sₜ^{c102} of the camera 107b includes the information of the type of the lens of the camera 107b, the information of the focal length of the camera 107b, the information of the lens focus of the camera 107b, the information of the diaphragm of the camera 107b, or the like.

The imaging range specification unit 52 specifies imaging information Pₜ^{107b} of the camera 107b that defines the imaging range of the camera 107b such as the imaging position, the viewpoint center, or the imaging angle of view.

The imaging range specification unit 52 outputs the specified imaging information Pₜ^{107a} of the camera 107a to the overlapping region estimation unit 53. In addition, the imaging range specification unit 52 outputs the specified imaging information Pₜ^{107b} of the camera 107b to the overlapping region estimation unit 53.

The overlapping region estimation unit 53 extracts a combination in which the imaging information Pₜ^{107a} and Pₜ^{107b} overlap each other based on the imaging information Pₜ^{107a} of the camera 107a and the imaging information Pₜ^{107b} of the camera 107b which are input from the imaging range specification unit 52, and estimates an overlapping region between the frame image fₜ^{107a} and the frame image fₜ^{107b}. Normally, in a case where a panoramic image is generated, the frame image fₜ^{107a} and the frame image fₜ^{107b} are overlapped to a certain extent (for example, approximately 20%) in order to estimate transformation parameters required for projective transformation. However, because sensor information and the like of the unmanned aerial vehicles 101 and 102 or the cameras 107a and 107b often include an error, the overlapping region estimation unit 53 cannot accurately specify how the frame image fₜ^{107a} and the frame image fₜ^{107b} overlap each other only with the imaging information Pₜ^{107a} of the camera 107a and the imaging information Pₜ^{107b} of the camera 107b. Accordingly, the overlapping region estimation unit 53 estimates overlapping regions between the frame image fₜ^{107a} and the frame image fₜ^{107b} using a known image analysis technique.

Specifically, first, the overlapping region estimation unit 53 determines whether overlapping regions dₜ^{107a} and dₜ^{107b} between the frame image fₜ^{107a} and the frame image fₜ^{107b} can be calculated based on the imaging information Pₜ^{107a} and Pₜ^{107b}. An overlapping region which is a portion of the frame image fₜ^{107a} can be represented as an overlapping region dₜ^{107a} (first overlapping region). An overlapping region which is a portion of the frame image fₜ^{107b} can be represented as an overlapping region dₜ^{107b} (second overlapping region).

When determining that the overlapping regions dₜ^{107a} and dₜ^{107b} can be calculated, the overlapping region estimation unit 53 roughly calculates the overlapping regions dₜ^{107a} and dₜ^{107b} between the frame image fₜ^{107a} and the frame image fₜ^{107b} based on the imaging information Pₜ^{107a} and Pₜ^{107b}. The overlapping regions dₜ^{107a} and dₜ^{107b} are easily calculated based on the imaging position, the viewpoint center, the imaging angle of view, or the like included in the imaging information Pₜ^{107a} and Pₜ^{107b}. On the other hand, when determining that the overlapping regions dₜ^{107a} and dₜ^{107b} between the frame image fₜ^{107a} and the frame image fₜ^{107b} cannot be calculated, for example, due to the unmanned aerial vehicles 101 and 102 moving greatly or the like, the overlapping region estimation unit 53 does not calculate the overlapping regions dₜ^{107a} and dₜ^{107b} between the frame image fₜ^{107a} and the frame image fₜ^{107b}.

Next, the overlapping region estimation unit 53 determines whether the error of the rough overlapping regions dₜ^{107a} and dₜ^{107b} calculated based only on the imaging information Pₜ^{107a} and Pₜ^{107b} exceeds a threshold (the presence or absence of the error).

When determining that the error of the overlapping regions dₜ^{107a} and dₜ^{107b} exceeds the threshold, because the overlapping region dₜ^{107a} and the overlapping region dₜ^{107b} do not overlap each other correctly the overlapping region estimation unit 53 calculates the amounts of shift mₜ^{107a, 107b} of the overlapping region dₜ^{107b} with respect to the overlapping region dₜ^{107a} required for overlapping the overlapping region dₜ^{107a} and the overlapping region dₜ^{107b}. The overlapping region estimation unit 53 applies, for example, a known image analysis technique such as template matching to the overlapping regions dₜ^{107a} and dₜ^{107b} to calculate the amounts of shift mₜ^{107a, 107b}. On the other hand, when determining that the error of the overlapping regions dₜ^{107a} and dₜ^{107b} is equal to or less than the threshold, that is, when the overlapping region dₜ^{107a} and the overlapping region dₜ^{107b} overlap each other correctly, the overlapping region estimation unit 53 does not calculate the amounts of shift mₜ^{107a, 107b} of the overlapping region dₜ^{107b} with respect to the overlapping region dₜ^{107a} (the amounts of shift mₜ^{107a, 107b} are considered to be zero).

Here, the amount of shift refers to a vector indicating the number of pixels in which the shift occurs and a difference between images including a direction in which the shift occurs. A correction value is a value used to correct the amount of shift, and refers to a value different from the amount of shift. For example, in a case where the amount of shift refers to a vector indicating a difference between images meaning that a certain image shifts by “one pixel in a right direction” with respect to another image, the correction value refers to a value for returning a certain image by “one pixel in a left direction” with respect to another image.

Next, the overlapping region estimation unit 53 corrects the imaging information Pₜ^{107a} and Pₜ^{107b} based on the calculated amounts of shift mₜ^{107a, 107b}. The overlapping region estimation unit 53 performs a backward calculation from the amounts of shift mₜ^{107a, 107b} to calculate correction values Cₜ^{107a} and Cₜ^{107b} for correcting the imaging information Pₜ^{107a} and Pₜ^{107b}. The correction value Cₜ^{107a} (first correction value) is a value used to correct the imaging information Pₜ^{107a} of the camera 107a that defines the imaging range of the camera 107a such as the imaging position, the viewpoint center, or the imaging angle of view. The correction value Cₜ^{107b} (second correction value) is a value used to correct the imaging information Pₜ^{107b} of the camera 107b that defines the imaging range of the camera 107b such as the imaging position, the viewpoint center, or the imaging angle of view.

The overlapping region estimation unit 53 corrects the imaging information Pₜ^{107a} using the calculated correction value Cₜ^{107a}, and calculates corrected imaging information Pₜ^{107a}′. In addition, the overlapping region estimation unit 53 corrects the imaging information Pₜ^{107b} using the calculated correction value Cₜ^{107b}, and calculates corrected imaging information Pₜ^{107b}′.

Meanwhile, in a case where there are three or more cameras, there are as many of the calculation values of the amount of shift and the correction values of the imaging information as the number of combinations. Accordingly, in a case where the number of cameras is large, it is only required that the overlapping region estimation unit 53 applies a known optimization method such as, for example, a linear programming approach to calculate optimum values such as the imaging position, the viewpoint center, or the imaging angle of view, and corrects the imaging information using an optimized correction value for minimizing a shift between images as a whole system.

Next, the overlapping region estimation unit 53 calculates corrected overlapping region dₜ^{107a}′ and corrected overlapping region dₜ^{107b}′ based on the corrected imaging information Pₜ^{107a}′ and the corrected imaging information Pₜ^{107b}′. That is, the overlapping region estimation unit 53 calculates the corrected overlapping region dₜ^{107a}′ and the corrected overlapping region dₜ^{107b}′ which are corrected so as to minimize a shift between images. The overlapping region estimation unit 53 outputs the corrected overlapping region dₜ^{107a}′ and the corrected overlapping region dₜ^{107b}′ which are calculated to the transformation parameter calculation unit 54. Meanwhile, in a case where the amounts of shift mₜ^{107a, 107b} are considered to be zero, the overlapping region estimation unit 53 does not calculate the corrected overlapping region dₜ^{107a}′ and the corrected overlapping region dₜ^{107b}′.

The transformation parameter calculation unit 54 calculates a transformation parameter H required for projective transformation using a known method based on the corrected overlapping region dₜ^{107a}′ and the corrected overlapping region dₜ^{107b}′ which are input from the overlapping region estimation unit 53. The transformation parameter calculation unit 54 calculates the transformation parameter H using the overlapping region corrected by the overlapping region estimation unit 53 so as to minimize a shift between images, such that the accuracy of calculation of the transformation parameter H can be improved. The transformation parameter calculation unit 54 outputs the calculated transformation parameter H to the frame image synthesis unit 55. Meanwhile, in a case where the error of the overlapping regions dₜ^{107a} and dₜ^{107b} is equal to or less than the threshold, and the overlapping region estimation unit 53 considers the amounts of shift mₜ^{107a, 107b} to be zero, it is only required that the transformation parameter calculation unit 54 calculates the transformation parameter H using a known method based on the overlapping region dₜ^{107a} before correction and the overlapping region dₜ^{107b} before correction.

The frame image synthesis unit 55 performs projective transformation on the frame image fₜ^{107a} and the frame image fₜ^{107b} based on the transformation parameter H which is input from the transformation parameter calculation unit 54. The frame image synthesis unit 55 then synthesizes a frame image fₜ^{107a}′ after the projective transformation and a frame image fₜ^{107b}′ after the projective transformation (an image group projected onto one plane), and generates a highly-realistic high-definition panoramic video. The frame image synthesis unit 55 outputs the generated highly realistic panoramic image to the display device 106.

As illustrated in FIG. 2, the display device 106 includes a frame image display unit 61. The frame image display unit 61 displays the highly-realistic high-definition panoramic video which is input from the frame image synthesis unit 55. Meanwhile, for example, in a case where synthesis using the transformation parameter H cannot be performed due to an unmanned aerial vehicle temporarily moving greatly or the like, the display device 106 may perform exceptional display again until the overlapping region can be estimated. For example, processing such as displaying only one of the frame images or displaying information for specifying to a system user that an image of a separate region is captured is performed.

As described above, the panoramic video synthesis system 100 according to the present embodiment includes the frame image acquisition unit 11, the state information acquisition unit 12, the imaging range specification unit 52, the overlapping region estimation unit 53, the transformation parameter calculation unit 54, and the frame image synthesis unit 55. The frame image acquisition unit 11 acquires the frame image fₜ^{107a} captured by the camera 107a mounted on the unmanned aerial vehicle 101 and the frame image fₜ^{107b} captured by the camera 107b mounted on the unmanned aerial vehicle 102. The state information acquisition unit 12 acquires the first state information indicating the state of the unmanned aerial vehicle 101, the second state information indicating the state of the camera 107a, the third state information indicating the state of the unmanned aerial vehicle 102, and the fourth state information indicating the state of the camera 107b. The imaging range specification unit 52 specifies first imaging information that defines the imaging range of the camera 107a based on the first state information and the second state information, and specifies second imaging information that defines the imaging range of the camera 107b based on the third state information and the fourth state information. The overlapping region estimation unit 53 calculates the overlapping region dₜ^{107a} in the frame image fₜ^{107a} and the overlapping region dₜ^{107b} in the frame image fₜ^{107b} based on the first imaging information and the second imaging information, and calculates corrected overlapping regions dₜ^{107a}′ and dₜ^{107b}′ obtained by correcting the overlapping regions ₜ^{107a} and dₜ^{107b} in a case where the error of the overlapping regions dₜ^{107a} and dₜ^{107b} exceeds the threshold. The transformation parameter calculation unit 54 calculates transformation parameters for performing the projective transformation on the frame images fₜ^{107a} and fₜ^{107b} using the corrected overlapping regions dₜ^{107a}′ and dₜ^{107b}′. The frame image synthesis unit 55 performs the projective transformation on the frame images fₜ^{107a} and fₜ^{107b} based on the transformation parameters, and synthesizes the frame image fₜ^{107a}′ after the projective transformation and the frame image fₜ^{107b}′ after the projective transformation.

According to the panoramic video synthesis system 100 of the present embodiment, the imaging information of each camera is calculated based on the state information of a plurality of unmanned aerial vehicles and the state information of cameras mounted on each unmanned aerial vehicle. A spatial correspondence relation between frame images is first estimated based only on the imaging information, the imaging information is further corrected by image analysis, an overlapping region is accurately specified, and then image synthesis is performed. Thereby, even in a case where each of a plurality of unmanned aerial vehicles moves arbitrarily, it is possible to accurately specify an overlapping region, and to improve the accuracy of synthesis between frame images. Thus, it is possible to generate a highly-realistic high-definition panoramic video with high accuracy utilizing the lightweight properties of an unmanned aerial vehicle without firmly fixing a plurality of cameras.

Image Processing Method

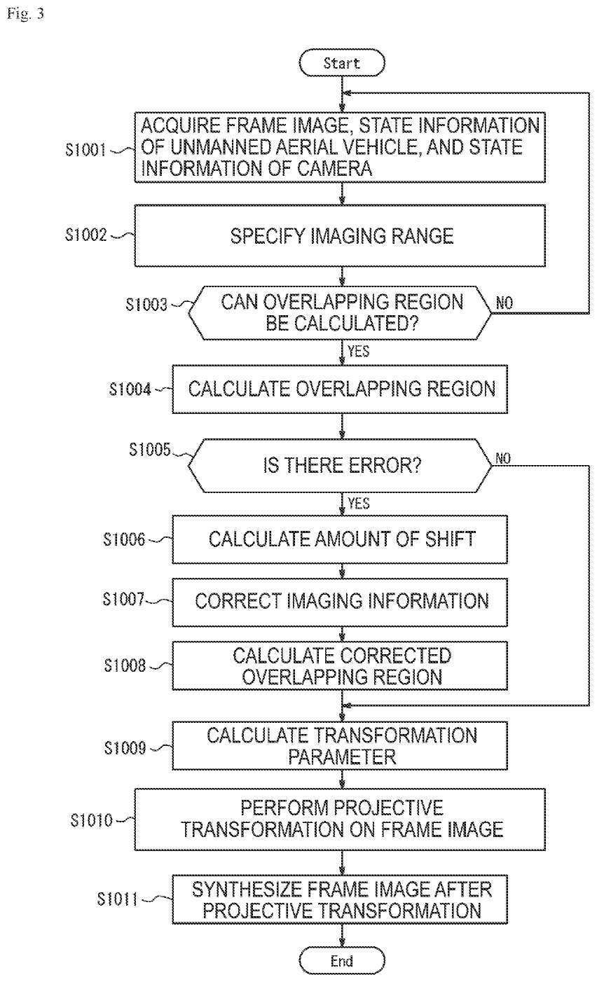

Next, an image processing method according to an embodiment of the present invention will be described with reference to FIG. 3.

In step S1001, the calculator 105 acquires, for example, the frame image fₜ^{107a} captured by the camera 107a and the frame image fₜ^{107b} captured by the camera 107b at time t. In addition, the calculator 105 acquires, for example, the state information Sₜ^{v101} indicating the state of the unmanned aerial vehicle 101, the state information Sₜ^{v102} indicating the state of the unmanned aerial vehicle 102, the state information Sₜ^{c101} indicating the state of the camera 107a, and the state information Sₜ^{c102} indicating the state of the camera 107b at time t.

In step S1002, the calculator 105 specifies the imaging range of the camera 107a based on the state information Sₜ^{v101} of the unmanned aerial vehicle 101 and the state information Sₜ^{c101} of the camera 107a. In addition, the calculator 105 specifies the imaging range of the camera 107b based on the state information Sₜ^{v102} of the unmanned aerial vehicle 102 and the state information Sₜ^{c102} of the camera 107b. The calculator 105 then specifies the imaging information Pₜ^{107a} and Pₜ^{107b} of the cameras 107a and 107b that define the imaging ranges of the cameras 107a and 107b such as the imaging position, the viewpoint center, or the imaging angle of view.

In step S1003, the calculator 105 determines whether the overlapping regions dₜ^{107a} and dₜ^{107b} between the frame image fₜ^{107a} and the frame image fₜ^{107b} can be calculated based on the imaging information Pₜ^{107a} and Pₜ^{107b}. In a case where it is determined that the overlapping regions dₜ^{107a} and dₜ^{107b} between the frame image fₜ^{107a} and the frame image fₜ^{107b} can be calculated based on the imaging information Pₜ^{107a} and Pₜ^{107b} (step S1003→YES), the calculator 105 performs the process of step S1004. In a case where it is determined that the overlapping regions dₜ^{107a} and dₜ^{107b} between the frame image fₜ^{107a} and the frame image fₜ^{107b} cannot be calculated based on the imaging information Pₜ^{107a} and Pₜ^{107b} (step S1003→NO), the calculator 105 performs the process of step S1001.

In step S1004, the calculator 105 roughly calculates the overlapping regions dₜ^{107a} and dₜ^{107b} between the frame image fₜ^{107a} and the frame image fₜ^{107b} based on the imaging information P₁^{107a} and Pₜ^{107b}.

In step S1005, the calculator 105 determines whether the error of the overlapping regions dₜ^{107a} and dₜ^{107b} calculated based only on the imaging information Pₜ^{107a} and Pₜ^{107b} exceeds the threshold. In a case where it is determined that the error of the overlapping regions dₜ^{107a} and dₜ^{107b} exceeds the threshold (step S1005→YES), the calculator 105 performs the process of step S1006. In a case where it is determined that the error of the overlapping regions dₜ^{107a} and dₜ^{107b} is equal to or less than the threshold (step S1005→NO), the calculator 105 performs the process of step S1009.

In step S1006, the calculator 105 calculates the amounts of shift mₜ^{107a, 107b} of the overlapping region dₜ^{107b} with respect to the overlapping region dₜ^{107a} required for overlapping the overlapping region dₜ^{107a} and the overlapping region dₜ^{107b}. The calculator 105 applies, for example, a known image analysis technique such as template matching to the overlapping regions dₜ^{107a} and dₜ^{107b} to calculate the amounts of shift mₜ^{107a, 107b}.

In step S1007, the calculator 105 calculates the correction values Cₜ^{107a} and Cₜ^{107b} for correcting the imaging information Pₜ^{107a} and Pₜ^{107b} based on the amounts of shift mₜ^{107a, 107b}. The calculator 105 corrects the imaging information Pₜ^{107a} using the correction value Cₜ^{107b} to calculate the corrected imaging information Pₜ^{107a}′, and corrects the imaging information Pₜ^{107b} using the correction value Cₜ^{107b} to calculate the corrected imaging information Pₜ^{107b}′.

In step S1008, the calculator 105 calculates the corrected overlapping region dₜ^{107a}′ and the corrected overlapping region dₜ^{107b}′ based on the corrected imaging information Pₜ^{107a}′ and the corrected imaging information Pₜ^{107b}′.

In step S1009, the calculator 105 calculates the transformation parameter H required for the projective transformation using a known method based on the corrected overlapping region dₜ^{107a}′ and the corrected overlapping region dₜ^{107b}′.

In step S1010, the calculator 105 performs the projective transformation on a frame image fₜ^{107a}′ and a frame image fₜ^{107b}′ based on the transformation parameter H.

In step S1011, the calculator 105 synthesizes the frame image fₜ^{107a}′ after the projective transformation and the frame image fₜ^{107b}′ after the projective transformation, and generates a highly-realistic high-definition panoramic video.

According to the image processing method of the present embodiment, the imaging information of each camera is calculated based on the state information of a plurality of unmanned aerial vehicles and the state information of cameras mounted on each unmanned aerial vehicle. A spatial correspondence relation between frame images is first estimated based only on the imaging information, the imaging information is further corrected by image analysis, an overlapping region is accurately specified, and then image synthesis is performed. Thereby, even in a case where each of a plurality of unmanned aerial vehicles moves arbitrarily, it is possible to accurately specify an overlapping region, and to improve the accuracy of synthesis between frame images, and thus it is possible to generate a highly realistic high-definition panoramic video with high accuracy utilizing the lightweight properties of an unmanned aerial vehicle without firmly fixing a plurality of cameras.

### Modification Example

In the image processing method according to the present embodiment, processing from the acquisition of the frame images fₜ^{107a}′ and fₜ^{107b} and the state information Sₜ^{v101}, Sₜ^{v102}, Sₜ^{c101}, and Sₜ¹⁰² to the synthesis of the frame images fₜ^{1077a}′, and fₜ^{107b}′ after projective transformation have been described using an example of using the calculator 105. However, the present invention is not limited thereto, and the processing may be performed on the unmanned aerial vehicles 102 and 103.

Program and Recording Medium

It is also possible to use a computer capable of executing a program command in order to function as the embodiment and the modification example described above. The computer can realize the program describing process contents for realizing the function of each device by storing in a storage unit of the computer, and reading out and executing this program using a processor of the computer, and at least a portion of the process contents may be realized by hardware. Here, the computer may be a general-purpose computer, a dedicated computer, a workstation, a personal computer (PC), an electronic notepad, or the like. The program command may be a program code, a code segment, or the like for executing necessary tasks. The processor may be a central processing unit (CPU), a graphics processing unit (GPU), a digital signal processor (DSP), an application specific integrated circuit (ASIC), or the like.

For example, referring to FIG. 3, a program for causing a computer to execute the above-described image processing method includes: step S1001 of acquiring a first frame image captured by the first camera 107a mounted on the first unmanned aerial vehicle 101 and a second frame image captured by the second camera 107b mounted on the second unmanned aerial vehicle 102; step S1002 of acquiring first state information indicating a state of the first unmanned aerial vehicle 101, second state information indicating a state of the first camera 107a, third state information indicating a state of the second unmanned aerial vehicle 102, and fourth state information indicating a state of the second camera 107b, specifying first imaging information that defines an imaging range of the first camera 107a based on the first state information and the second state information, and specifying second imaging information that defines an imaging range of the second camera 107b based on the third state information and the fourth state information; steps S1003 to S1008 of calculating a first overlapping region in the first frame image and a second overlapping region in the second frame image based on the first imaging information and the second imaging information, and calculating a corrected first overlapping region obtained by correcting the first overlapping region and a corrected second overlapping region obtained by correcting the second overlapping region in a case where an error of the first overlapping region and the second overlapping region exceeds a threshold; step S1009 of calculating transformation parameters for performing projective transformation on the first frame image and the second frame image using the corrected first overlapping region and the corrected second overlapping region; and steps S1010 and S1011 of performing the projective transformation on the first frame image and the second frame image based on the transformation parameters, and synthesizing the first frame image after the projective transformation and the second frame image after the projective transformation.

In addition, this program may be recorded in a computer readable recording medium. It is possible to install the program on a computer by using such a recording medium. Here, the recording medium having the program recorded thereon may be a non-transitory recording medium. The non-transitory recording medium may be a compact disk-read only memory (CD-ROM), a digital versatile disc (DVD)-ROM, a BD (Blu-ray (trade name) Disc)-ROM, or the like. In addition, this program can also be provided by download through a network.

Although the above-described embodiment has been described as a representative example, it should be obvious to those skilled in the art that many changes and substitutions can be made within the spirit and scope of the present disclosure. Accordingly, the present invention should not be construed as being limited to the above-described embodiment, and various modifications and changes can be made without departing from the scope of the claims. For example, it is possible to combine a plurality of configuration blocks described in the configuration diagram of the embodiment into one, or to divide one configuration block. In addition, it is possible to combine a plurality of steps described in the flow chart of the embodiment into one, or to divide one step.

### REFERENCE SIGNS LIST

11 Frame image acquisition unit
12 State information acquisition unit
21 Frame image acquisition unit
22 State information acquisition unit
51 Frame image reception unit
52 Imaging range specification unit
53 Overlapping region estimation unit
54 Transformation parameter calculation unit
55 Frame image synthesis unit
61 Frame image display unit
100 Panoramic video synthesis system
101, 102, 103 Unmanned aerial vehicle
104 Radio reception device
105 Calculator (image processing device)
106 Display device
107a, 107b, 107c Camera

1. An image processing system configured to synthesize a plurality of frame images captured by a plurality of cameras mounted on a plurality of unmanned aerial vehicles, the image processing system configured to:
acquire a first frame image captured by a first camera mounted on a first unmanned aerial vehicle and a second frame image captured by a second camera mounted on a second unmanned aerial vehicle;
acquire first state information that indicates a state of the first unmanned aerial vehicle, second state information that indicates a state of the first camera, third state information that indicates a state of the second unmanned aerial vehicle, and fourth state information that indicates a state of the second camera;
specify first imaging information that defines an imaging range of the first camera based on the first state information and the second state information, specify second imaging information that defines an imaging range of the second camera based on the third state information and the fourth state information;
calculate a first overlapping region in the first frame image and a second overlapping region in the second frame image based on the first imaging information and the second imaging information, and calculate, in a case where an error of the first overlapping region and the second overlapping region exceeds a threshold, a corrected first overlapping region obtained by correcting the first overlapping region and a corrected second overlapping region obtained by correcting the second overlapping region;
calculate a transformation parameter for performing projective transformation on the first frame image and the second frame image using the corrected first overlapping region and the corrected second overlapping region; and
perform projective transformation on the first frame image and the second frame image based on the transformation parameter, and synthesize the first frame image after the projective transformation and the second frame image after the projective transformation.

2. The image processing system according to claim 1, wherein, when the error exceeds the threshold, the image processing system is further configured to:
calculate an amount of shift of the second overlapping region with respect to the first overlapping region,
calculate a first correction value for correcting the first imaging information and a second correction value for correcting the second imaging information, based on the amount of shift, and
calculate the corrected first overlapping region and the corrected second overlapping region, based on corrected first imaging information obtained by correcting using the first correction value and corrected second imaging information obtained by correcting using the second correction value.

3. (canceled)

4. (canceled)

5. An image processing method of synthesizing a plurality of frame images captured by a plurality of cameras mounted on a plurality of unmanned aerial vehicles, the image processing method comprising:
acquiring a first frame image captured by a first camera mounted on a first unmanned aerial vehicle and a second frame image captured by a second camera mounted on a second unmanned aerial vehicle;
acquiring first state information that indicates a state of the first unmanned aerial vehicle, second state information that indicates a state of the first camera, third state information that indicates a state of the second unmanned aerial vehicle, and fourth state information that indicates a state of the second camera;
specifying first imaging information that defines an imaging range of the first camera based on the first state information and the second state information, and specifying second imaging information that defines an imaging range of the second camera based on the third state information and the fourth state information;
calculating a first overlapping region in the first frame image and a second overlapping region in the second frame image, based on the first imaging information and the second imaging information, and in a case where an error of the first overlapping region and the second overlapping region exceeds a threshold, calculating a corrected first overlapping region obtained by correcting the first overlapping region and a corrected second overlapping region obtained by correcting the second overlapping region;
calculating a transformation parameter for performing projective transformation on the first frame image and the second frame image using the corrected first overlapping region and the corrected second overlapping region; and
performing projective transformation on the first frame image and the second frame image based on the transformation parameter, and synthesizing the first frame image after the projective transformation and the second frame image after the projective transformation.

6. The image processing method according to claim 5, wherein, when the error exceeds the threshold, the calculating of the overlapping region further comprises:
calculating an amount of shift of the second overlapping region with respect to the first overlapping region;
calculating, based on the amount of shift, a first correction value for correcting the first imaging information and a second correction value for correcting the second imaging information; and
calculating the corrected first overlapping region and the corrected second overlapping region, based on corrected first imaging information obtained using the first correction value and corrected second imaging information obtained using the second correction value.

7. (canceled)

8. The image processing method according to claim 6, wherein the amount of shift is represented by a vector indicating a number of pixels in which the shift occurs and a difference between images.

9. The image processing method according to claim 5, wherein the first state information comprises at least one of:
altitude information; or
posture information;

10. The image processing method according to claim 9, wherein the second state information comprises at least one of:
orientation information for the first camera;
lens information for the first camera;
lens focus information for the first camera; or
diaphragm information for the first camera.

11. The image processing method according to claim 10, further comprising transmitting the first state information and the second state information to a radio reception device.

12. The image processing method according to claim 5, further comprising generating, based upon the synthesis, a high-definition panoramic video.

13. A non-transitory computer-readable medium comprising computer executable instruction that, when executed by at least one processor, performs a method comprising:
acquiring a first frame image captured by a first camera mounted on a first unmanned aerial vehicle and a second frame image captured by a second camera mounted on a second unmanned aerial vehicle;
acquiring first state information that indicates a state of the first unmanned aerial vehicle, second state information that indicates a state of the first camera, third state information that indicates a state of the second unmanned aerial vehicle, and fourth state information that indicates a state of the second camera;
specifying first imaging information that defines an imaging range of the first camera based on the first state information and the second state information, and specifying second imaging information that defines an imaging range of the second camera based on the third state information and the fourth state information;
calculating a first overlapping region in the first frame image and a second overlapping region in the second frame image, based on the first imaging information and the second imaging information, and in a case where an error of the first overlapping region and the second overlapping region exceeds a threshold, calculating a corrected first overlapping region obtained by correcting the first overlapping region and a corrected second overlapping region obtained by correcting the second overlapping region;
calculating a transformation parameter for performing projective transformation on the first frame image and the second frame image using the corrected first overlapping region and the corrected second overlapping region; and
performing projective transformation on the first frame image and the second frame image based on the transformation parameter, and synthesizing the first frame image after the projective transformation and the second frame image after the projective transformation.

14. The non-transitory computer-readable medium according to claim 13, wherein, when the error exceeds the threshold, the calculating of the overlapping region further comprises:
calculating an amount of shift of the second overlapping region with respect to the first overlapping region;
calculating, based on the amount of shift, a first correction value for correcting the first imaging information and a second correction value for correcting the second imaging information; and
calculating the corrected first overlapping region and the corrected second overlapping region, based on corrected first imaging information obtained using the first correction value and corrected second imaging information obtained using the second correction value.

15. The non-transitory computer-readable medium to claim 14, wherein the amount of shift is represented by a vector indicating a number of pixels in which the shift occurs and a difference between images.

16. The non-transitory computer-readable medium according to claim 13, wherein the first state information comprises at least one of:
altitude information; or
posture information;

17. The non-transitory computer-readable medium according to claim 16, wherein the second state information comprises at least one of:
orientation information for the first camera;
lens information for the first camera;
lens focus information for the first camera; or
diaphragm information for the first camera.

18. The non-transitory computer-readable medium according to claim 17, further comprising transmitting the first state information and the second state information to a radio reception device.

19. The non-transitory computer-readable medium according to claim 13, wherein the method further comprises generating, based upon the synthesis, a high-definition panoramic video.

20. The image processing system according to claim 2, wherein the amount of shift is represented by a vector indicating a number of pixels in which the shift occurs and a difference between images.

21. The image processing system according to claim 1, wherein the first state information comprises at least one of:
altitude information; or
posture information;

22. The image processing system according to claim 21, wherein the second state information comprises at least one of:
orientation information for the first camera;
lens information for the first camera;
lens focus information for the first camera; or
diaphragm information for the first camera.

23. The image processing system according to claim 1, wherein the image processing system is further configured to generate, based upon the synthesis, a high-definition panoramic video.
